(19) United States
(12) Patent Application Publication
(10) Pub. No.: US 2007/0102465 A1
(43) Pub. Date: May 10, 2007

(54) LOAD CARRIER FOR MOTOR VEHICLES

(75) Inventors: Wojciech Wezyk, Sindelfingen (DE); Emil Schnell, Bad Friedrichshall (DE)

Correspondence Address: BROOKS KUSHMAN P.C., 1000 TOWN CENTER, TWENTY-SECOND FLOOR, SOUTHFIELD, MI, 48075, US

(73) Assignee: MAGNA CAR TOP SYSTEMS GMBH, Bietigheim-Bissingen (DE)

(21) Appl. No.: 11/558,737

(22) Filed: Nov. 10, 2006

(30) Foreign Application Priority Data
Nov. 10, 2005 (DE) 10 2005 054 059.7

(51) Int. Cl. B60R 9/00

(52) U.S. Cl. 224/321; 224/924

(57) ABSTRACT

A load carrier, such as a bicycle carrier, for a motor vehicle includes a support frame. The front section of the support frame, relative to the forward direction of vehicle travel, leading toward the vehicle may be shortened in length from a rearwardly extended position of the load carrier by being folded up.

### CROSS-REFERENCE TO RELATED APPLICATIONS

This application claims foreign priority benefits under 35 U.S.C. § 119(a)-(d) to DE 10 2005 054 059.7, filed Nov. 10, 2005, which is hereby incorporated by reference in its entirety.

### BACKGROUND OF THE INVENTION

1. Field of the Invention

The present invention relates to load carrier for motor vehicles.

2. Background Art

DE 40 41 085 A1 describes a load carrier for motor vehicles. The load carrier has a support frame having longitudinally extending carrier structures which are telescopically extendable. The load carrier further includes longitudinally extending guides which are laterally spaced apart from one another. The guides receive the carrier structures. In a rearwardly extended functional position of the load carrier, the carrier structures form a load receiving element. The load carrier may be converted to a stowed position in which the telescoping sections of the carrier structures are brought together in the region of the load receiving element. In this brought-together position, supporting parts of the load receiving element associated with the telescoping sections rest compactly stowed at the rear of the vehicle inside an enclosure formed by a bumper. For example, the supports are for supporting the wheels of bicycles. The enclosure, as a component of a carrier structure, in the functional position of the load carrier forms a frame for the load carrier when extended to the rear, opposite the direction of forward vehicle travel. The segmented design of the carrier structures for the part of the support frame forming the load receiving element in the functional position limits the possibility of integrating the load carrier into the contour of the vehicle.

This is also the case for another embodiment described in DE 40 41 085 A1. In this embodiment, the load carrier in the region of the supporting parts of the load receiving element has carrier supports associated with the carrier structures. The carrier supports may be swivelled about upright axes at the rear of the vehicle in a longitudinally dividable manner such that the carrier supports may be folded accordion-style, and in the stowed position of the load carrier may each be swivelled in toward the rear of the vehicle.

DE 42 31 568 A1 describes a load carrier for motor vehicles. The load carrier is a component of a bumper unit which may be extended at the rear of the vehicle. With its lateral legs, which are connected by a center bridge part, the bumper forms a frame for a load receiving element. The frame is supported on carrier structures running parallel to the legs of the bumper and mounted so as to be longitudinally displaceable with respect to the vehicle. The legs of the bumper adjoin the vehicle contour in the longitudinal direction of the vehicle via accordion-like extendable enclosure parts. The enclosure parts extend in the longitudinal direction of the vehicle. The enclosure parts are brought together in the stowed position of the load carrier. The enclosure parts form a closed transition section between the vehicle structure and the legs of the bumper in the functional position of the load carrier.

DE 296 15 884 U1 describes a load carrier with longitudinal lateral U-shaped guide tracks. The guide tracks are fixed to the vehicle and have mutually open cross sections. The longitudinal extending carrier structures of the support frame are guided in the guide tracks. The support frame is formed by the carrier structures and the transverse elements connecting same, whereby the extended section of the support frame is used as a load receiving element and the support frame may be locked in its retracted and in its extended position.

DE 296 14 67 U1 describes integrating a load carrier onto a vehicle in which the load carrier may be converted from its functional position, projecting at the rear beyond the vehicle contour, to a stowed position. In the stowed position, the load carrier is folded up and pushed toward or into the rear of the vehicle with corresponding locking of the respective adjustment positions. As the load carrier with respect to its load receiving element has the same structure and dimensions in both the stowed and functional positions, and for a longitudinally displaceable design of the load carrier the longitudinal extending carrier structures thereof have a region on the front side which is in front of the load receiving element and used for guiding, a relatively large insertion depth for the load carrier, proceeding from the rear of the vehicle, is a result.

### SUMMARY OF THE INVENTION

An object of the present invention is a load carrier having a large extension length with a minimized insertion depth in the stowed position, regardless of whether the base structure of the load carrier is maintained in the region of its load receiving element.

In carrying out the above object and other objects, the present invention provides a load carrier for a motor vehicle. The load carrier includes a pair of longitudinally extending guides fixable to a vehicle. The guides are laterally spaced apart from one another and run parallel to one another. The load carrier further includes a support frame having a pair of longitudinally extending first and second carrier structures which are laterally spaced apart from one another. The carrier structures are associated with the guides to be longitudinal displaceable to move the load carrier between a stowed position in which the load carrier is longitudinally collapsed to a functional position in which the load carrier is longitudinally extended rearwardly. The support frame has front and rear sections respectively including front and rear sections of the carrier structures. The front section of the support frame including the front section of the carrier structures is guided via the guides and the rear section of the support frame including the rear section of the carrier structures project beyond the guides to form a load receiving element when the load carrier is in the functional position. In a transition region between the front and rear sections of the support frame, the carrier structures are longitudinally divided and in the stowed position of the load carrier the carrier structures are folded together in the front section of the support. In the functional position of the load carrier the rear section of the second carrier structure is laterally swivellable out with respect to the front section of the second carrier structure by a swivel connection having an upright swivel axis.

In an embodiment of the present invention, the longitudinal lateral carrier structures of the front section of the support frame, i.e., the section of the support frame in front of the load receiving element, may be folded up so that the insertion depth is reduced for the same size of the load receiving element in the functional and stowed positions, while at the same time a desired large guide length is provided for the load carrier in its functional position as the result of the unfolding when the load carrier is pulled out.

In addition, a relatively compact design is obtained for the load carrier without adversely affecting its load capacity, together with swiveling capability of the load receiving element with respect to the section of the load carrier guided on the vehicle side so that, for example for vehicles having a trunk lid or a tailgate, the load carrier together with its carried objects such as bicycles may be swivelled away from the access area for the tailgate or trunk lid. The swiveling capability is achieved by the separation of the carrier structures into a section guided on the vehicle side and a section associated with the load receiving element. The connection of the sections of the carrier structures is achieved for the one carrier structure by a swivel connection having an upright swivel axis. The swivel connection is designed such that the swivelled-out section of the carrier structure containing the swivel connection is extended in conjunction with the swivel motion.

In an embodiment of the present invention, such an approach for longitudinally dividing the carrier structures of the support frame in the transition between the front and rear sections thereof is realized in a simple manner as the one carrier structure has a joint to be closed by a locking connection, and the other carrier structure has a swivel connection such as a wing hinge. For a swivel connection designed in the manner of a hinge for swinging doors, in the transition to the outwardly swivelable section of the carrier structure an intermediate member is provided. The intermediate member is articulately swivellable at both ends, and which in the extended position of the carrier structure containing the swivel connection extends in the direction of the carrier structure and is situated between the folded-together sections of the carrier structure.

Such a folded position of the swivel connection may be secured by a locking device. The locking device may be provided by a transversely tightened screw connection or a lock which acts on one of the pivot pins.

The locking connection provided in the one carrier structure, analogous to the swivel connections in the other carrier structure, is achieved in a robust and simple design by sockets. The sockets are associated with the sections of the carrier structure and which in their connecting position for the sections of the carrier structure to be joined via the locking connection are connected to legs inserted in the sockets via a bridge member.

The above features, and other features and advantages of the present invention as readily apparent from the following detailed descriptions thereof when taken in connection with the accompanying drawings.

### BRIEF DESCRIPTION OF THE DRAWINGS

FIG. 1 illustrates a top perspective view of a load carrier such as a bicycle carrier for a motor vehicle in which the load carrier is associated with the vehicle so as to be retractable and extendable at the rear in accordance with an embodiment of the present invention;

FIG. 2 illustrates a top view of the load carrier showing the vehicle contour and the guides of the load carrier situated in the bottom region of the vehicle and extending in the longitudinal direction of the vehicle;

FIG. 3 illustrates a view corresponding to FIG. 2 with the load carrier in its functional position, pulled away from the vehicle, and the load receiving element with its bicycle wheel supports swivelled out;

FIG. 4 illustrates a view corresponding to FIG. 3 depicting a support arm for bicycles to be placed on the load receiving element of the load carrier;

FIG. 5 illustrates a view of the load carrier with bicycles placed on the load receiving element of the load carrier;

FIG. 6 illustrates a view corresponding to FIG. 5 with the load receiving element together with the bicycles placed thereon displaced from the transport position for the bicycles, according to FIG. 5, to a laterally swivelled-out position with respect to the direction of forward vehicle travel, showing the access position for a tailgate or trunk lid of the vehicle;

FIGS. 7 and 8 illustrate enlarged views of the swivel connection in the one carrier structure, and the locking thereof; and

FIGS. 9 and 10 illustrate enlarged views of the locking connection associated with the other carrier structure.

### DETAILED DESCRIPTION OF THE PREFERRED EMBODIMENT(S)

In the figures, elements that are the same and elements having the same function are labeled with the same reference numbers.

With references to the Figures, a load carrier 1 for a motor vehicle 2 in accordance with an embodiment of the present invention is shown. Motor vehicle 2 is preferably a passenger vehicle such as a sport-utility vehicle. Load carrier 1 is to be situated in the longitudinal center of the bottom region of vehicle 2 and extendable at the rear. The contour of vehicle 2 is illustrated in the Figures with the longitudinal center axis of vehicle 2 denoted by reference numeral 3.

Load carrier 1 is fixed to vehicle 2. Load carrier 1 includes guides 4, 5 on each longitudinally extending side of load carrier 1. Guides 4, 5 extend parallel to longitudinal center axis 3. Load carrier 1 includes a support frame 8 having a pair of longitudinally extending carrier structures 6, 7. Carrier structures 6, 7 are laterally spaced apart from one another. Carrier structures 6, 7 are respectively guided and supported in guides 4, 5.

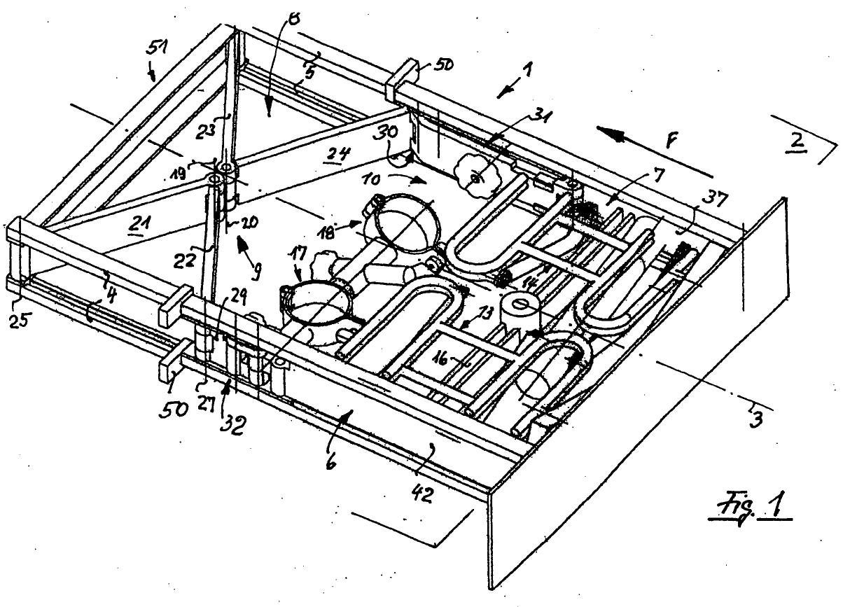

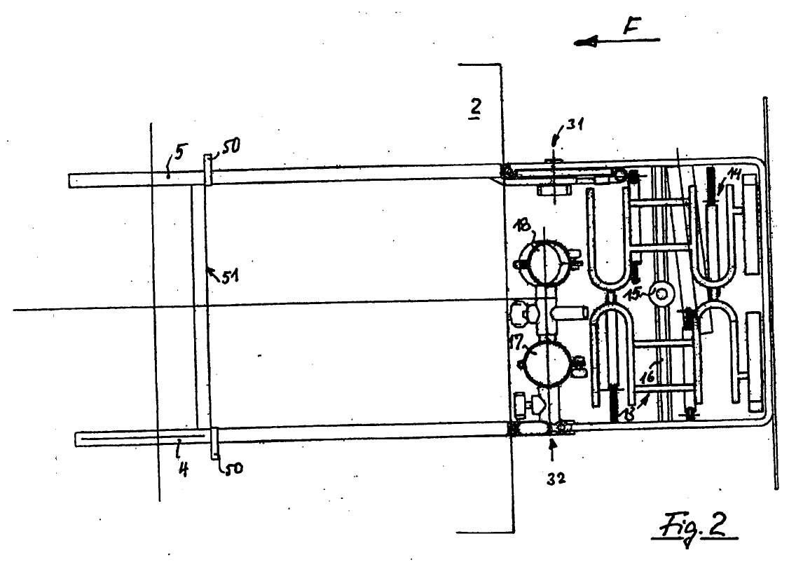

Support frame 8 has a front section 9 and a rear section 10 relative to the direction of forward vehicle travel F. Front section 9 is adjustable in length along a direction parallel to longitudinal center axis 3. In the stowed position of load carrier 1 (i.e., when load carrier 1 is pushed into vehicle 2 as shown in FIG. 1), front section 9 of support frame 8 is folded up to be compact in length in a direction parallel to longitudinal center axis 3. In the functional position of load carrier 1 (i.e., when load carrier 1 is extended to the rear as shown in FIG. 2), front section 9 is pulled apart (i.e., is longitudinally extended) in such a way that carrier structures 6, 7 have the same extension as guides 4, 5.

Rear section 10 of support frame 8 functions as a load receiving element. In this embodiment, rear section 10 functions as a load receiving element for transporting bicycles 11, 12. As such, accessory parts of rear section 10 for transporting bicycles 11, 12 include a pair of holders 13, 14 and a central support arm 15. Each holder 13, 14 is to receive the wheels of a respective bicycle 11, 12. Holders 13, 14 swivel out transversely with respect to longitudinal center axis 3 for receiving the wheels of bicycles 11, 12. Central support arm 15 is a reversible telescoping support. Central support arm 15 is fastened to a transverse strut 16 of rear section 10 of support frame 8. Central support arm 15 is provided with frame mountings 17, 18 for respectively holding bicycles 11, 12. Frame mountings 17, 18 are fixable to rear section 10 of support frame 8 in opposite alignment at the rear, transversely to longitudinal center axis 3.

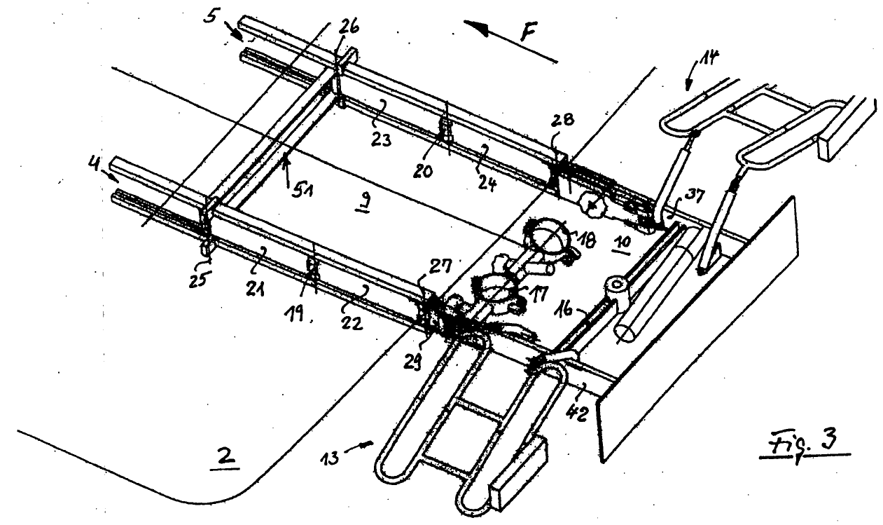

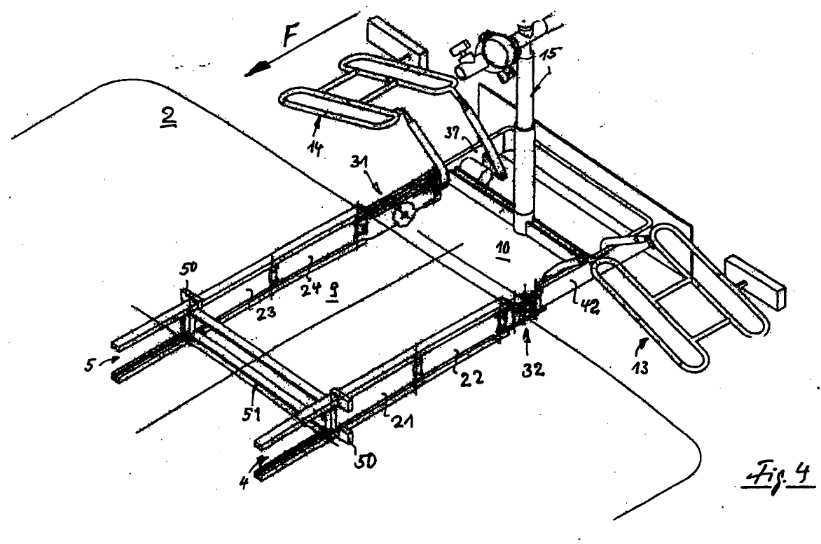

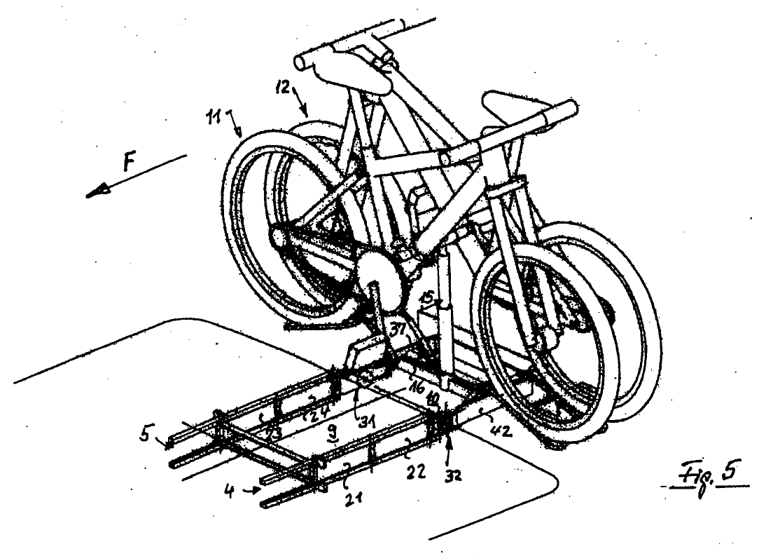

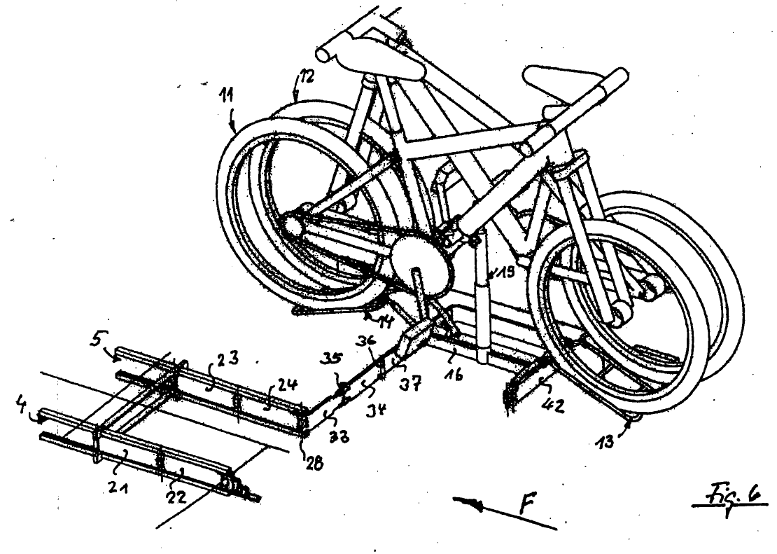

FIGS. 1 and 2 illustrate accessory parts 13, 14, 15, 16, 17, 18 of rear section 10 in their stored position. FIGS. 3 and 4 illustrate the accessory parts in transition positions between the stored position and mounted positions. FIGS. 5 and 6 illustrate the accessory parts in the mounted positions for receiving bicycles 11, 12.

Rear section 10, which forms the load receiving element, is dimensionally stable and rigidly connected to front section 9 in both the stowed and functional (i.e., rearwardly extended) positions load carrier 1. The structure of front section 9 is formed by carrier structures 6, 7. Carrier structure 6 includes a pair of guide rods 21, 22 and carrier structure 7 includes a pair of guide rods 23, 24. Guide rods 21, 22 are connected at one end by a hinge 19 and guide rods 23, 24 are connected at one end by a hinge 20. Guide rods 21, 22 are held in a longitudinally displaceable manner in guides 4 at their ends opposite from hinge 19 (i.e., opposite from the folding axis defined by hinge 19). Likewise, guide rods 23, 24 are held in a longitudinally displaceable manner in guides 5 at their ends opposite from hinge 20 (i.e, opposite from the folding axis defined by hinge 20). To this end, guide rods 21, 22, 23, 24 may be respectively swivelled relative to carrier structures 6, 7 about an upright axis, at their ends connected to the respective carrier structures 6, 7 opposite from hinges 19, 20.

An upright swivel axis 25 is associated with the front end, relative to the forward direction of vehicle travel, of guide rod 21. Likewise, an upright swivel axis 26 is associated with the front end of guide rod 23. Swivel axes 25, 26 are fixed with respect to a transverse support 51 of support frame 8. Transverse support 51 is guided so as to be longitudinally displaceable with respect to guides 4, 5. An upright swivel axis 27 is associated with the rear end of guide rod 22 and an upright swivel axis 28 is associated with the rear end of guide rod 24. Swivel axes 27, 28 are fixed in a longitudinally displaceable manner with respect to guides 4, 5 via respective support elements 29, 30. Support elements 29, 30 are respectively part of the connection between front and rear sections 9, 10 of carrier structures 6, 7. Swivel axes 27, 28 in this transition region enable rear section 10 to convert to a swivel position which with respect to front section 9 is outwardly offset relative to longitudinal center axis 3 such that bicycles 11, 12 received by rear section 10 extend in the longitudinal direction of vehicle 2, and at the rear end of the vehicle, at least in the overlap region, access is provided to a trunk lid or tailgate of vehicle 2 which may be present.

The transition region between front and rear sections 9, 10 of carrier structures 6, 7 is adjacent to the rear end of vehicle 2 when load carrier 1 is extended such that front section 9 together with the corresponding sections of carrier structures 6, 7 is situated in guides 4, 5 fixed to the vehicle, whereas rear section 10 including the load receiving element project rearwardly beyond the vehicle such that carrier structures 6, 7 in this region are situated outside guides 4, 5.

For converting rear section 10 and its load receiving element to the laterally swiveled-out position, carrier structures 6, 7 are longitudinally divided. The sections of carrier structure 6 associated with front and rear sections 9, 10 are connected to one another via a swivel connection 31. Swivel connection 31 is provided with an articulated connection designed in the manner of a wing hinge. This articulated connection allows an enlarged lateral overhang for the load receiving element of rear section 10. Carrier structure 7 has a locking connection 32 which is opened for swiveling out rear section 10.

Swivel connection 31 adjoins a support element 30 by which guide rod 24 is guided in a longitudinally displaceable manner in guide 4 via swivel axis 28. A pivot pin encompassing swivel axis 28 may be used as support element 30. One hinge arm 33 of swivel connection 31 is connected to guide rod 24 via swivel axis 28. At the other end of hinge arm 33 an additional hinge arm in the form of an intermediate member 34 is linked via a swivel axis 35. The connection is made via a swivel axis 36 to a longitudinal arm 37 of carrier structure 7. Longitudinal arm 37 extends in alignment with corresponding guide in the stowed and functional positions of load carrier 1.

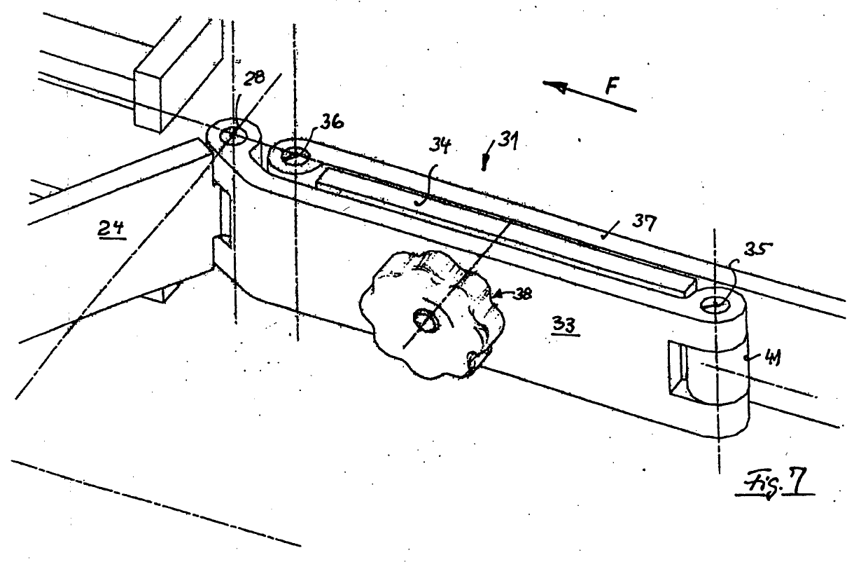

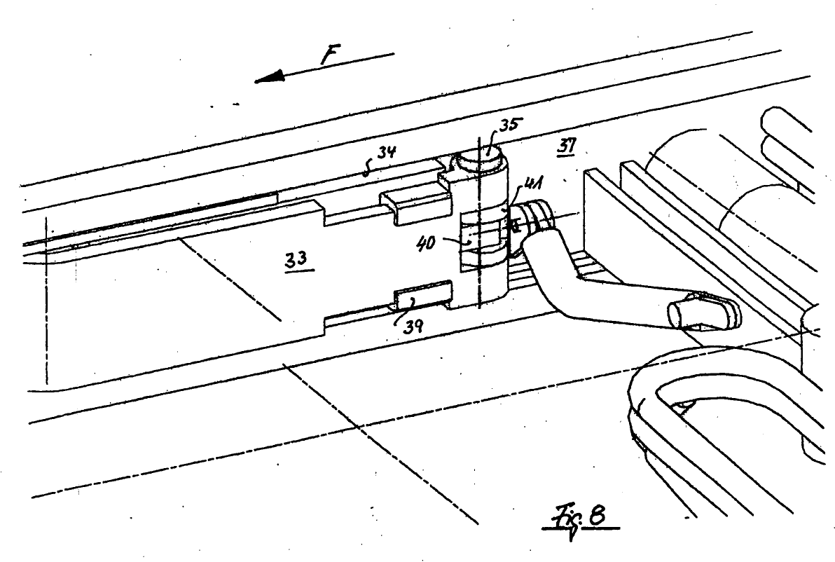

As shown in FIG. 7, the closed position of the wing hinge in swivel connection 31 may be achieved by transverse tightening by a screw connection 38. Alternatively, as shown in FIG. 8, the closed position of the wing hinge may be achieved by transverse tightening by a latch bolt 39 which is displaceable along hinge arm 33. In its locked position, latch bolt 39 together with its locking bar 40 overlap a flat side of hinge eye 41 of intermediate member 34. Intermediate member 34 is connected to hinge arm 33 via axis 35. When the lock between hinge arm 33 and intermediate member 34 is released, the wing hinge forming swivel connection 31 may be folded out. This results in an enlarged overhang for the load receiving element of rear region 10 in the outwardly folded swivel position. This occurs because longitudinal arm 37 is connected to guide 5 via hinge arm 33 and intermediate member 34. FIG. 6 shows that in the swivelled-out position the swivel path is stop-limited by the respective hinge connections.

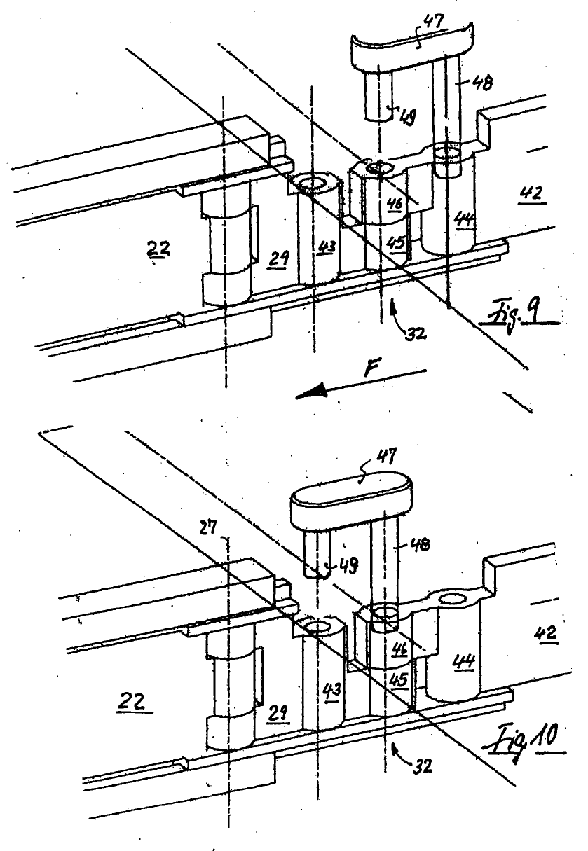

As shown in FIGS. 9 and 10, a robust and simple locking connection is achieved because, at the joint between front and rear sections 9, 10 of carrier structure 7, support element 29 on one side and side arm 42 on the other side each have a respective socket 43, 44. Sockets 43, 44 have axes parallel to swivel axis 27, by which support element 29 is connected to guide rod 22. Each of sockets 43, 44 is joined by a projection to another respective socket 45, 46. In the axial direction sockets 43, 44 is shorter than respective bearing sockets 43, 44. Sockets 45, 46 have the same axial length, preferably half as long as sockets 43, 44. Sockets 45, 46 are placed in a coaxial, mutually overlapping position corresponding to the closed position of locking connection 32. This closed position is fixed in place because the mutually overlapping, coaxially positioned half-sockets 45, 46 are fixed with respect to one another with the assistance of a bridge member 47. Bridge member 47 has a U-shaped base shape with parallel legs 48, 49 in the form of socket pins. Leg 48 has a length which is at least greater than the length of one of half-sockets 45, 46 to be axially fixed in place relative to one another in the overlapping position. The other leg 49 is shorter than upper socket 46. In conjunction with the fact that support element 29 is longitudinally displaceable with respect to guide 4, i.e., is designed as a sliding block, for example, and that socket 43 and half-socket 45 are associated with support element 29 which is guided as a sliding block, longitudinal and transverse locking is achieved via bridge member 47 when half-sockets 45 and 46 are fixed with respect to one another in their coaxial position by longer leg 48 (FIG. 10), and shorter leg 49 is inserted into one of the other sockets 43, 44. The lock may be released and locking connection 32 opened by shifting bridge member 47 (FIG. 9). Other locking connections may also be used within the scope of the present invention, of course, although the present locking connection is distinguished by its extreme simplicity and robustness, and securing bridge member 47 in the unlocked position may be ensured by accommodation in two sockets.

FIG. 1 shows load carrier 1 in its stowed position (i.e., pushed into vehicle 2). In the stowed position of load carrier 1, front section 9 is shortened by folding accordion-style guide rods 21, 22 and 23, 24 which are part of respective carrier structures 6, 7. Each pair of guide rods 21, 22; 23, 24 forms isosceles triangles pointing toward one another. The guide rods may be used to delimit the insertion path by the fact that for a specified insertion length the apexes of the respective triangles formed by the guide rods abut one another, thus preventing further insertion motion. In the extended position of guide rods 21, 22; 23, 24, rear guide rods 22, 24 end in the region of the rear boundary of vehicle 2 so that when carrier structures 6, 7 are opened in this region the rear area of support frame 8 may be converted from its functional position (shown in FIG. 2) to a laterally swivelled-out position (shown in FIG. 6), for example. The extension motion of load carrier 1 may be easily stop-limited by the fact that support frame 8 with its rear transverse support 51 abuts against stops 50 provided on the side of guides 4, 5 (FIG. 2). After the connection between front and rear sections 9, 10 is opened, the load receiving element formed by rear section 10 may be converted to the laterally swivelled-out position shown in FIG. 6. This swivelled-out position also preferably is stop-limited, in particular by a corresponding design of the swivel connection by limit stops. The return from the swivelled-out position to the locking functional position is achieved by locking connection 32 according to the present invention, which allows alignment with the extended end position corresponding to the functional position when the overlapping position is fixed between half-sockets 45, 46 by inserting the one long leg 48 of bridge member 47. Short leg 49 preferably engages with socket 43 associated with support element 29. Locking connection 32 is opened only when long leg 48 engages with socket 44 which is fixed with respect to longitudinal arm 42, when short leg 49 engages with half-socket 46 which is fixed with respect to socket 44 and which, relative to closed locking connection 32, rests above half-socket 45 which is fixed with respect to support element 29 and is adjacent to the bar of bridge member 47 bearing legs 48, 49.

While embodiments of the present invention have been illustrated and described, it is not intended that these embodiments illustrate and describe all possible forms of the present invention. Rather, the words used in the specification are words of description rather than limitation, and it is understood that various changes may be made without departing from the spirit and scope of the present invention.

What is claimed is:

1. A load carrier for a motor vehicle, the load carrier comprising:
a pair of longitudinally extending guides fixable to a vehicle, the guides are laterally spaced apart from one another and run parallel to one another;
a support frame having a pair of longitudinally extending first and second carrier structures which are laterally spaced apart from one another, the carrier structures are associated with the guides to be longitudinal displaceable to move the load carrier between a stowed position in which the load carrier is longitudinally collapsed to a functional position in which the load carrier is longitudinally extended rearwardly, the support frame having front and rear sections respectively including front and rear sections of the carrier structures;
wherein the front section of the support frame including the front section of the carrier structures is guided via the guides and the rear section of the support frame including the rear section of the carrier structures project beyond the guides to form a load receiving element when the load carrier is in the functional position;
wherein in a transition region between the front and rear sections of the support frame, the carrier structures are longitudinally divided and in the stowed position of the load carrier the carrier structures are folded together in the front section of the support;
wherein in the functional position of the load carrier the rear section of the second carrier structure is laterally swivellable out with respect to the front section of the second carrier structure by a swivel connection having an upright swivel axis.

2. The load carrier of claim 1 wherein:
the first carrier structure includes a locking connection spanning a joint between the front and rear sections of the first carrier structure, and the swivel connection includes a wing hinge.

3. The load carrier of claim 2 wherein:
the swivel connection includes a hinge arm between the front and rear sections of the second carrier structure as an intermediate member, the hinge arm is articulately connected the sections of the second carrier structure, respectively;
wherein in the extended position of the second carrier structure the hinge arm extends in the direction of the second carrier structure and is situated between the sections of the second carrier structure.

4. The load carrier of claim 2 wherein:
the swivel connection includes articulated hinge arms via swivel axes at the front section and the rear section of the second carrier structure, whereby the hinge arms are connected via a swivel axis and are able to swivel between a position corresponding to a stowed position state of the second carrier structure and a folded-out extension position which increases the distance between the front and rear sections of the second carrier structure.

5. The load carrier of claim 2 wherein:
in the closed state of the first carrier structure the swivel connection between the front section and the rear section of the second carrier structure is lockable.

6. The load carrier of claim 2 wherein:
the locking connection from the front section to the rear section of the first carrier structure has an upright holder for an insertable bracket-shaped bridge member, and parts of the first carrier structure are connectable to one another via the locking connection in a longitudinally and transversely rigid manner.

7. The load carrier of claim 6 wherein:
each holder includes a socket, the sockets are each circumferentially connected to an additional socket, respectively, in a rigid, vertically offset manner, and the vertically offset sockets coaxially overlap one another when the joint is closed and are aligned with one another by a leg of a bridge member, the other leg of which engages with one of the other sockets.

8. The load carrier of claim 7 wherein:
the legs of the bridge member have different lengths, and the length of the shorter leg is less than or equal to the insertion length of the socket, adjacent to the bridge member in the insertion position, of the coaxially aligned sockets.

9. The load carrier of claim 8 wherein:
the load carrier is a bicycle carrier.

10. The load carrier of claim 1 wherein:
the carrier structures are folded accordion-style in the front section of the support frame when the load carrier is in the stowed position.

11. The load carrier of claim 1 wherein:
the carrier structures in the front section of the support frame fold together, and in the region of their ends opposite from the folding axis each have guide rods which are guided in the guides in a longitudinally displaceable manner.
